(19) United States
(12) Patent Application Publication
(10) Pub. No.: US 2003/0070032 A1
(43) Pub. Date: Apr. 10, 2003

(54) Local area network compliant with universal serial bus standard

(76) Inventors: Kuo-Min Tsao, Taipei (TW); Wen-Jen Wu, Taipei (TW)

Correspondence Address: BIRCH STEWART KOLASCH & BIRCH, PO BOX 747, FALLS CHURCH, VA, 22040-0747, US

(21) Appl. No.: 10/254,777

(22) Filed: Sep. 26, 2002

(30) Foreign Application Priority Data
Oct. 9, 2001 (TW) 90125020

(51) Int. Cl. G06F 13/36

(52) U.S. Cl. 710/313; 710/314

(57) ABSTRACT

A local area network compliant with universal serial bus (USB) standard includes a USB switching hub and a plurality of hosts. The USB switching hub is used for packet transmission and receiving, wherein the USB switching hub is compliant with USB standard. Each of the hosts is coupled to the USB switching hub. Each of the hosts includes a network control unit and a USB host unit. By the USB switching hub for packet transmission, USB can be used as a way of communicating among the hosts. Thus, networking can be achieved without network cards, resulting in convenience in use and reduced costs.

This application incorporates by reference Taiwan application Serial No. 090125020, filed on Oct. 9, 2001.

### BACKGROUND OF THE INVENTION

1. Field of the Invention

The invention relates in general to a local area network (LAN), and more particularly to a LAN compliant with universal serial bus (USB) standard.

2. Description of the Related Art

As computers are in widespread use, data transmission between the computers becomes more and more frequently. Different computers connected together form a computer network so as to exchange data among them. Referring to FIG. 1, a conventional LAN 100 includes a number of hosts 110 and an Ethernet switching hub 102. Each of the hosts 110, such as a personal computer, includes a network control unit 112 and a network interface card 114. When an executing application in the host 110 needs to send data to the network, the data to be sent is first transferred to the network control unit 112, and then the network control unit 112 converts the data into one or more packets P. The packets P are outputted to the network interface card 114, and the network interface card 114 sends the packets P to the Ethernet switching hub 102. Next, the Ethernet switching hub 102 sends the destined host 110 or another Ethernet network 120 according to the destination address specified in the packets P. The packets P sent from the Ethernet switching hub 102 are received by an network interface card 114 of the destined host 110, and the network interface card 114 then transfers the received packets P to the network control unit 112 of the destined host 110.

For connecting personal computers to form a computer network, the network interface cards are needed to be installed into the personal computers conventionally since the network interface cards are not built in the common personal computers. Thus, the users have to install the network cards themselves inconveniently and spend additional costs on the network cards.

In addition, there is a variety of computer peripherals, such as digital cameras, scanners, keyboards, and mice, and a standard for facilitating the computer peripherals using a common data bus, universal serial bus (USB), becomes more popularly used. The computer peripherals compliant with USB have the advantages of communicating with the computers with the same common interface in a high speed. Besides, USB supports plug-and-play (PnP) functionality so that installation of the USB compliant peripherals becomes more easily. Since USB compliant peripherals are in widespread use now, almost every computer now has a built-in USB host as a central controller for communication of the computer host and its USB compliant peripherals.

### SUMMARY OF THE INVENTION

It is therefore an object of the invention to provide a local area network (LAN) compliant with universal serial bus (USB) standard.

The invention achieves the above-mentioned object by providing a LAN compliant with USB standard including a USB switching hub and a plurality of hosts. The USB switching hub is used for packet transmission and receiving, wherein the USB switching hub is compliant with USB standard. Each of the hosts is coupled to the USB switching hub. Each of the hosts includes a network control unit and a USB host unit. The network control unit is used for outputting packets according to a request from an application program executed in the host, and for outputting data to the application program according to received packets. The USB host unit is coupled to the USB switching hub and the network control unit, and is used for transmitting packets outputted from the network control unit to the USB switching hub, receiving packets outputted from the USB switching hub, and outputting the received packets to the network control unit.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) illustrates a conventional local area network.

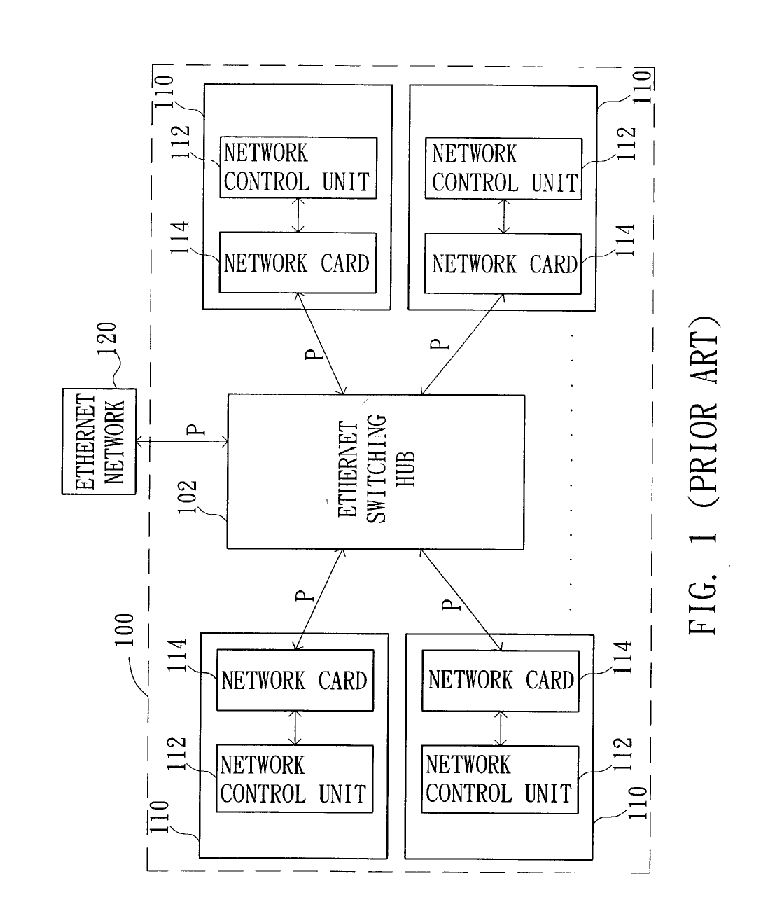

FIG. 2 illustrates a LAN compliant with USB standard according a preferred embodiment of the invention.

FIG. 3 illustrates a switching hub compliant with USB standard.

### DETAILED DESCRIPTION OF THE INVENTION

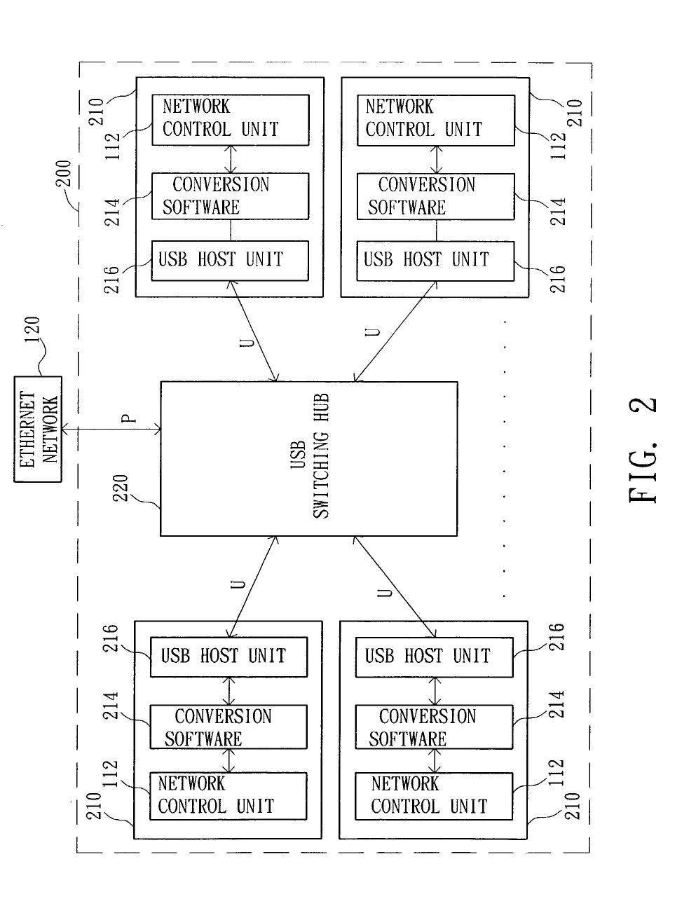

The principle of the invention is to use the USB of the computers for connecting to the outside networks. A LAN compliant with USB standard is illustrated in FIG. 2 according to the embodiment of the invention. The USB compliant LAN 200 includes a number of hosts 210 and a USB switching hubs 220, wherein the USB switching hubs 220 is compliant with USB standard. Each of the hosts 210, such as a computer, includes a network control unit 112, conversion software 214, and a USB host unit 216. When an executing application program AP in one of the hosts 210 needs to send data to the network, the data to be sent is first transferred to the network control unit 112 of the host 210, and then the network control unit 112 converts the data to be sent into one or more network packets P. The conversion software 214 then receives the network packets P and converts the network packets P into packets U compliant with USB standard, that is, USB packets U. The USB host unit 216 outputs the USB packets U to the USB switching hub 200. Next, the USB switching hub 220 sends the USB packets U to the destined host 210, and the USB packets are received by the conversion software 214 of the destined host 210. The conversion software 214 of the destined host 210 converts the received USB packets U into corresponding network packets P and outputs the corresponding packets P to the network control unit 112 of the destined host 112. Thus, by the operation of the conversion software 214 and the USB host unit 216 in the host 210, the functionality of the conventional network interface card 114 can be replaced.

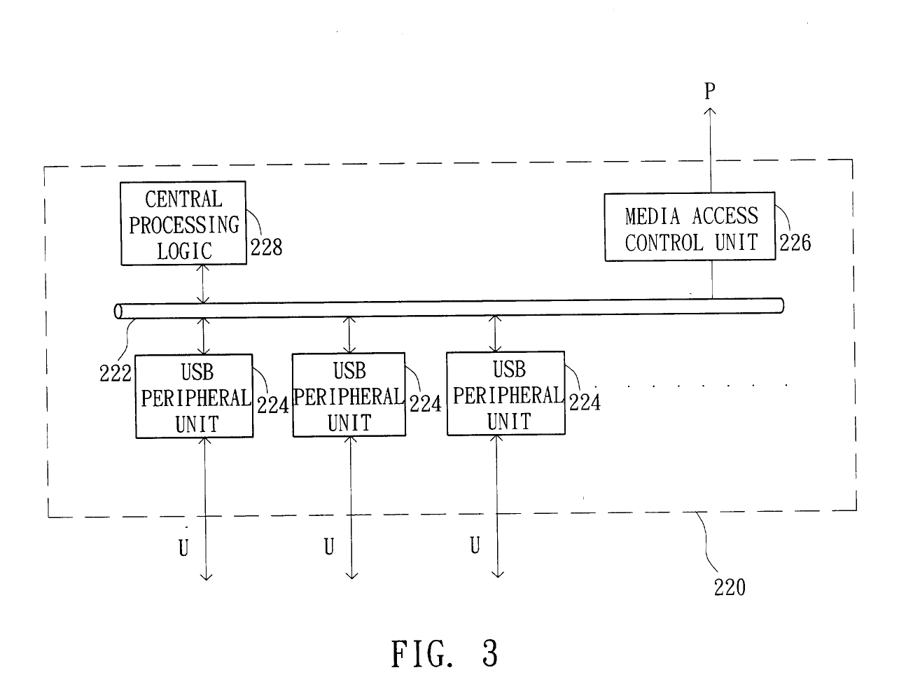

FIG. 3 illustrates the USB switching hub 220. The USB switching hub 220 includes a peripheral bus 222, multiple USB peripheral units 224, a medium access control (MAC) unit 226, and central processing logic 228. The USB peripheral units 224 are electronically coupled to the peripheral bus 222. Each of the USB peripheral units is further capable of being electronically coupled to one of the USB host units 216, in order to result in a virtual USB peripheral for transmitting USB packets U to and receiving USB packets U from the corresponding host 210. The MAC unit 226 is electronically coupled to the peripheral bus 222. In addition, the MAC unit 226 and is capable of being coupled to the Ethernet network 120 for receiving network packets P from the Ethernet network 120 and transmitting network packets P to the Ethernet network 120. The central processing logic 228 is electronically coupled to the peripheral bus 222, and is used for receiving network packets P or USB packets U and outputting either network packets P or USB packets U after conversion according to the received packets' destinations.

When one of the hosts 210 needs to send data to the Ethernet network 120, the host 210 sends USB packets U to the USB switching hub 220. The corresponding USB peripheral unit 224 then sends the USB packets to the central processing logic 228. Once receiving the USB packets U, the central processing logic 228 converts the received USB packets U into corresponding network packets P, sends the corresponding network packets P to the MAC unit 226 so as to outputs them to the Ethernet network 120.

When two of the hosts 210 in the USB compliant LAN 200 communicate with each other, the USB switching hub 220 transfers USB packets U received from the sending host to the receiving host according to the destination address in the USB packets U.

When network packets P of the Ethernet network 120 are to be sent to one of the hosts 210, the MAC unit 226 receives the network packets P and sends the received network packets P to the central processing logic 228. The central processing logic 228 then converts the received network packets P into USB packets U and sends the USB packets to a destined one of the hosts 210.

It should be noted that the conversion software 214 mentioned above is not essential to the invention, and the transmission and receiving of the packets can be performed directly by way of the USB host unit 216 and network control unit 112. In addition, the USB switching hub 220 can be used independent of the Ethernet network 120. In this case, a USB switching hub according to the invention can be operative without the MAC unit 226.

In the LAN compliant with USB standard according to the above-disclosed embodiment of the invention, networking is achieved through USB. Since USB is a standard peripheral data bus for computers nowadays, networking can be achieved according to the invention without the need of installing additional network interface cards into the computers. Therefore, networking can be achieved more conveniently and in reduced costs.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A local area network compliant with universal serial bus (USB) standard, comprising:
a USB switching hub for transmitting a first packet and for receiving a second packet, wherein the USB switching hub is compliant with USB standard; and
a plurality of hosts, coupled to the USB switching hub, for receiving the first packet from the USB switching hub, and for transmitting the second packet to the USB switching hub, each of the hosts comprising:
a network control unit for outputting the second packet according to a request from a program executed in the host, and for outputting data to the program according to the received first packet; and
a USB host unit, coupled to the USB switching hub and the network control unit, for transmitting the second packet outputted from the network control unit to the USB switching hub, receiving the first packet from the USB switching hub, and outputting the received first packet to the network control unit.

2. The local area network compliant with USB standard according to claim 1, wherein each of the host further comprises:
a conversion program for receiving the second packet from the network control unit, converting the second packet into at least one USB packet, and outputting the at least one USB packet to the USB host unit, and for receiving the first packet from the USB host unit, converting the first packet into at least one packet compliant with Ethernet, and outputting the at least one packet compliant with Ethernet to the network control unit.

3. The local area network compliant with USB standard according to claim 1, wherein the USB switching hub is further capable of being coupled to an Ethernet network and is further used for transmitting and receiving a network packet.

4. The local area network compliant with USB standard according to claim 3, wherein the USB switching hub comprises:
a peripheral bus;
a plurality of USB peripheral units, coupled to the peripheral bus and capable of being coupled to the respective USB host units, for transmitting the first packet and receiving the second packet among the peripheral bus and the USB host units;
a media access control (MAC) unit, coupled to the peripheral bus and capable of being coupled to the Ethernet network, for transmitting and receiving the network packet; and
a central processing logic unit, coupled to the peripheral bus, for receiving packets including the network packet and the second packet, and outputting the packets individually after conversion according to the packets' destination.

5. A switching hub compliant with universal serial bus (USB) standard, for use in a local area network, the local area network having a plurality of hosts, the switching hub comprising:
a peripheral bus;
a plurality of USB peripheral units, coupled to the peripheral bus and capable of being coupled to the respective host units, for transmitting and receiving a packet among the peripheral bus and the hosts; and
a central processing logic unit, coupled to the peripheral bus, for receiving the packet, and outputting the packet according to the packet's destination after conversion.

6. The switching hub according to claim 5, wherein each of the hosts comprises:
a network control unit for outputting the packet according to a request from a program executed in the host, and for outputting data to the program according to the received packet; and
a USB host unit for forwarding the packet among the network control unit and the USB peripheral units.

7. The switching hub according to claim 6, wherein each of the host further comprises: a conversion program for receiving the packet from the network control unit, converting the packet into at least one USB packet, and outputting the at least one USB packet to the USB host unit, and for receiving the packet from the USB host unit, converting the packet into at least one packet compliant with Ethernet, and outputting the at least one packet compliant with Ethernet to the network control unit.

8. The switching hub according to claim 5, wherein the switching hub is further capable of being coupled to an Ethernet network, and the switching hub further comprises:
a media access control (MAC) unit, coupled to the peripheral bus and capable of being coupled to the Ethernet network, for transmitting a network packet to the Ethernet network and receiving a network packet from the Ethernet network.
